(19) United States
(12) Patent Application Publication
(10) Pub. No.: US 2008/0127061 A1
(43) Pub. Date: May 29, 2008

(54) Method and system for editing code

(76) Inventors: Bulent Kasman, Antioch, CA (US); Edmund Josel Dela Cruz, San Jose, CA (US)

Correspondence Address: FAY KAPLUN & MARCIN, LLP, 150 BROADWAY, SUITE 702, NEW YORK, NY, 10038, US

(21) Appl. No.: 11/541,894

(22) Filed: Oct. 2, 2006

(51) Int. Cl. G06F 9/44

(52) U.S. Cl. 717/106

(57) ABSTRACT

A system having a first view displaying a source user code corresponding to a user code running on a target device, a second view displaying a template for an independent code to be compiled separately from the user code and inserted into the running user code, wherein a user fills in data in the template, and a code generator generating source code for the independent code based on the data entered in the template, wherein the second view displays the source code after generation by the code generator. A method for displaying, in a first view, a source user code corresponding to a user code running on a target device displaying, in a second view, a template for an independent code to be compiled separately from the user code and inserted into the running user code, receiving input data in the template, and generating source code for the independent code based on the input data received in the template.

### INCORPORATION BY REFERENCE

The following application hereby incorporates by reference each of the following applications filed on an even date herewith, including the application titled “Method and System for Parameter Profile Compiling” by inventor Bulent Kasman in its entirety, the application titled “Method and System for Dynamic Patching of Software” by inventor Bulent Kasman in its entirety, and the application titled “Method and System for Dynamic Debugging of Software” by inventor Bulent Kasman in its entirety.

### BACKGROUND

The ability to build, debug, and deploy software programs onto a target device is critical to software development. Debugging often involves monitoring variables, parameters, and/or resources used in a software program. One conventional method of monitoring involves inserting print statements within the program's code and performing a diagnostics session. Monitoring may also be performed during specific times of the program's execution. For example, breakpoints are often used to pause or terminate program execution, allowing the developer perform a diagnostics session in order to view the status of the variables, parameters, and resources at the specified times. However, the conventional debugging methods described above are limited. Since changes to the program code are required during debugging, the program must be recompiled and re-executed in order to view the results of these changes. Thus, the conventional debugging methods cannot be applied to programs that are currently being executed without interrupting the operation of the programs.

Additional diagnostics interactions with the program code on the target device may also be required, such as downloading patches, extracting data related to program performance and servicing, and/or collecting parameter data relating to a business operating the program. The performance of these interactions may require diagnostics data storage on the target device, thereby limiting the resource of the target device and increasing the overhead required to effectively operate the program code once deployed onto the target device.

### SUMMARY OF THE INVENTION

The present invention relates to a method and system for editing code. According to an embodiment of the present invention, the system comprises a first view displaying a source user code corresponding to a user code running on a target device, a second view displaying a template for an independent code to be compiled separately from the user code and inserted into the running user code, wherein a user fills in data in the template, and a code generator generating source code for the independent code based on the data entered in the template, wherein the second view displays the source code after generation by the code generator. According to another embodiment of the present invention, the method comprising displaying, in a first view, a source user code corresponding to a user code running on a target device displaying, in a second view, a template for an independent code to be compiled separately from the user code and inserted into the running user code, receiving input data in the template, and generating source code for the independent code based on the input data received in the template. In a further embodiment of the present invention, the system comprises a memory storing a set of instructions and a processor executing the instructions, the set of instructions being operable to display, in a first view, a source user code corresponding to a user code running on a target device, display, in a second view, a template for an independent code to be compiled separately from the user code and inserted into the running user code, receive input data in the template, and generate source code for the independent code based on the input data received in the template.

### BRIEF DESCRIPTION OF THE DRAWINGS

FIG. 1 shows an exemplary embodiment of a system for software development according to exemplary embodiments of the present invention.

FIG. 2 shows an exemplary embodiment of a system for networked software development according to exemplary embodiments of the present invention.

FIG. 3 shows an exemplary editor for the user source code view of a running application and the sensorpoint editing view having sensorpoint template according to exemplary embodiments of the present invention.

FIG. 4 shows an exemplary method for editing a sensorpoint code prior to inserting into a running application on a target according to exemplary embodiments of the present invention.

### DETAILED DESCRIPTION

The present invention may be further understood with reference to the following description of exemplary embodiments and the related appended drawings, wherein like elements are provided with the same reference numerals. The present invention is related to systems and methods used to develop, test and debug software. Specifically, the present invention is related to systems and methods for creating and editing software modules that may be dynamically inserted into running code (e.g., software application, kernel, driver, etc.) on a deployed on an embedded device through remote interaction with the deployed device. For example, the software module may serve as a software patch for an application on the device, or to collect data from the deployed device for predictive servicing, or extract information from the device for diagnostic or business related purposes.

The editing software module may allow software developers and engineers to vary the functionality of the software modules. While each of the software modules may perform a wide variety of tasks, exemplary embodiments of the present invention provides for an editor that may be used to build the software models and place the software modules in the correct location within the code of the running deployed device in a field environment without shutting down or rebooting the device with instrumented software. This may be extremely useful when shutting down or rebooting the device is undesirable or even impossible. Without impacting the operating of the device, editing the code of the software module and the instrumentation locations within the source code may provide the most accurate information for diagnosing device performance and/or identifying any possible errors.

Software applications are often created on a host computing device and ported to a target device. This type of development is typical for embedded devices. An embedded device is any device that includes a processor or microcontroller that executes software to carry out desired functions. Normally, an embedded device has fewer resources than a general purpose computer, such as having a slower processor, less memory (cache, RAM, Flash, etc.), etc. Examples of embedded devices include mobile phones, personal digital assistants, smart phones, smart process monitoring devices (e.g., thermostats, pressure sensors, flow sensors, etc.), etc. The exemplary embodiments of the present invention will be described with reference to a diagnostic tool for such embedded devices. However, those skilled in the art will understand that the present invention may be implemented in, for example, a diagnostic tool for software executing on any type of device. As will be described in greater detail below, additional independent program code may be installed onto the target device in order to collect useful diagnostic information during the development of the software application. Embodiments of the present invention will be described with reference to the development of software applications for these target devices in both networked and non-networked environments.

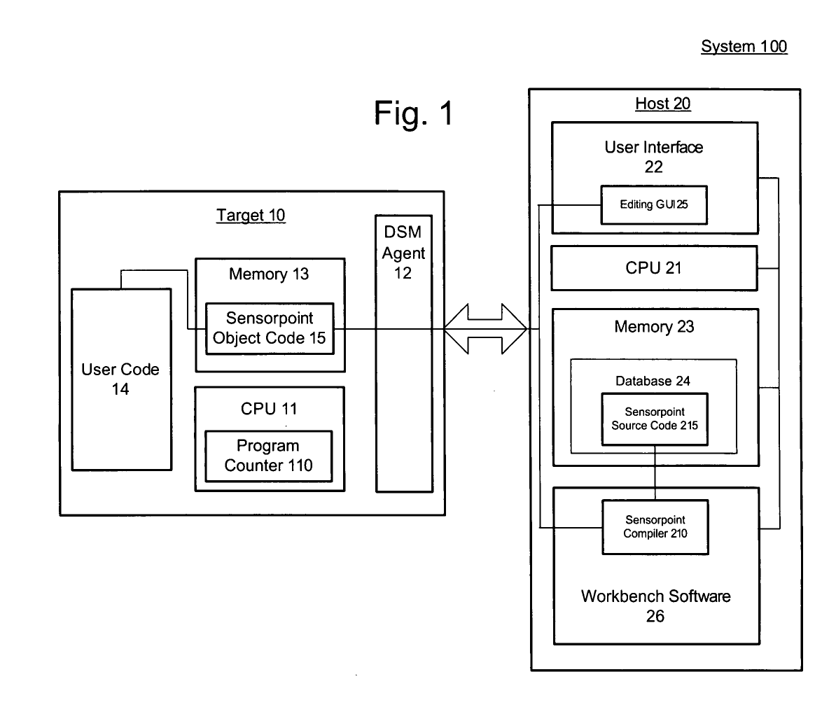

FIG. 1 shows an exemplary system 100 for integrating the editing, compiling and installing of program code within an application according to an exemplary embodiment of the present invention. The system 100 includes a target device 10 and a host device 20. In one embodiment, both the target 10 and the host 20 may be located in a lab environment, while in another embodiment, the target 10 and/or the host 20 may be in a field environment. For example, the target 10 may be deployed in a warehouse, office, etc., while the host resides in a laboratory or central server location. The host 20 may include conventional computing components such as a central processing unit (“CPU”) 21 (e.g., a microprocessor, an embedded controller, etc.) and a memory 23 (e.g., Random Access Memory, Read-only Memory, a hard disk, etc.). Likewise, the target 10 may also include a CPU 11 and a memory 13. Communication between the target 10 and the host 20 occurs over a communication link, which may be a wired (e.g., Ethernet, serial port, Universal Serial Bus, etc.) or wireless (e.g., Bluetooth, IEEE 802.1x, etc.) connection.

The host 20 may further include a user interface 22, a database 24, and workbench software 26. The user interface 22 enables a software developer to interact with the host 20 by receiving instructions and data requests. The user interface 22 may comprise any number of standard input and/or output devices, such as a keyboard, a mouse, a display, etc. The display of the user interface 22 may include an editing graphical user interface (“GUI”) 25 to provide the developer with a visual representation of programming code operating between the host 20 and the target 10. The editing GUI 25 will be described in further detail below. Throughout the description, the term developer will be used to refer to a user of the system and method disclosed herein, wherein a user may be, for example, a software engineer, a test engineer, a quality assurance engineer, support personnel, etc.

Through the user interface 22, the developer may instruct the host 20 to transmit data to and/or from the target 10. The data may include sensorpoint modules and monitoring data. As will be discussed in detail below, sensorpoint modules comprise program code that the developer can implement on the target 10. Monitoring data may include any relevant data that the developer wishes to receive from the target 10, such as device information, alarms and error messages, log information, and audit information (e.g., information related to users modifying devices and/or sensorpoint modules). The monitoring data may also relate to device type. For example, if the target 10 is a cell phone, the monitoring data may include call usage information, signal strength information, etc. The monitoring data may be transmitted automatically (e.g., at predetermined intervals) or upon request by the developer. For example, the user may request to view a log file generated by the target 10 in order to view specific program output.

The workbench software 26 is a software development tool used by the developer to create, modify, and debug software programs. The workbench software 26 may comprise a software suite that includes any number of individual software development programs, such as a compiler, a debugger, a source code analyzer, a text editor, etc. These individual programs may either be run independently of a running application or within a main development program. Using the workbench software 26, the user can create a sensorpoint module, write and edit code for the sensorpoint module, compile the code, abstract a parameter profile from the compiled code, and save the sensorpoint module to the database 24 of a local file system. Once the sensorpoint module is saved, it may be selected for transmission to the target 10. Those skilled in the art will understand that the sensorpoint code as written may not be the same as the actual code executed by the target 10. For example, the actual code may be an executable binary file created as a result of compiling and linking the sensorpoint code. The binary may be included in the sensorpoint module as an object file. In addition, the sensorpoint module may include multiple files, such as source, header and library files. These files may be installed individually or together with the entire sensorpoint module.

The database 24, or the local file system, stores sensorpoint modules, monitoring data (e.g., diagnostics logging data), and other types of data specified by the developer. The database 24 may also include user information, customer information, information regarding the target 10 (e.g., device type), parameter information regarding a business process, etc. The database 24 may be organized in any number of ways, including separate data structures for holding information corresponding to a specific target, a specific data type (e.g., sensorpoint modules), etc. The database 24 also allows for sensorpoint modules to be grouped together according to the specifications of the developer. For example, the developer may wish to group sub-components of a larger program together. The database 24 is located on writable memory 23, and may be accessed via the user interface 22.

The target 10 may further include a Device Software Management (DSM) agent 12 that may communicate with the host 20, specifically, for example, with the workbench software via the communication link. The DSM agent 12 coordinates the sending and receiving of data. Instructions and data requests are received by the DSM agent 12 and processed accordingly. When data is transmitted or received, the DSM agent 12 may first place the data into a buffer. For example, received sensorpoint modules may be temporarily stored in a buffer before writing to the memory 13 of the target 10. Likewise, data transmitted to the host 20 may first be placed in a buffer and sent when the data is ready for transmission and/or the host 20 is ready to receive the data. The DSM agent 12 may be implemented in hardware, software, or a combination thereof.

The target 10 operates using a user code 14, which comprises a program running in an operating system or a stand-alone program. The user code 14 may be written in any programming language (e.g., C/C++, Java, Assembly language, etc.). The user code 14 may be any program that the developer wishes to run on the target 10. For example, the user code 14 may be a main program or subroutine being developed for implementation on the target 10. The user code 14 may include source, header, library, object, and other data files.

The target 10 may also include sensorpoint object code 15. Similar to the user code 14, the sensorpoint object code 15 may include source, header, library and object files. According to the embodiments of the present invention described herein, a sensorpoint is defined as a piece of code that is compiled independently of a running application (e.g., the compiled user code 14). The sensorpoint object code 15 may be executed by the running application via branch instructions inserted into the running application (e.g., the executable binary). The sensorpoint object code 15 may include keywords for logging purposes, wherein the keywords may correspond to both sensorpoint directives (e.g., sensorpoint thread) and instrumentation points identifying the locations of the user code 14. The use of the keywords for the generation of parameter profiles will be described in detail below.

Those skilled in the art will understand that the system 100 and the various components described for the host 20 and the target 10 are only exemplary and are being used to illustrate an exemplary embodiment of an editor for writing and editing a sensorpoint that may be inserted into the target 10 according to the present invention. However, the exemplary editor according to the present invention may be implemented on systems that do not include sensorpoints. Those skilled in the art will understand that the functionality described for writing and editing of a sensorpoint may be implemented for writing other types of software code. Specifically, the functionality described for the editing of sensorpoints may be performed on any independent code, wherein the independent code is compiled separately from a target code and then inserted into the running target code. Such independent code may have the same characteristics as a sensorpoint (e.g., compiled code that is executed without interrupting the execution of the user code 14) or it may have different characteristics. Thus, the functionality of concern is the ability to write and edit software code that may be ported to a running target 10, without shutting down or rebooting the target 10 with instrumented software.

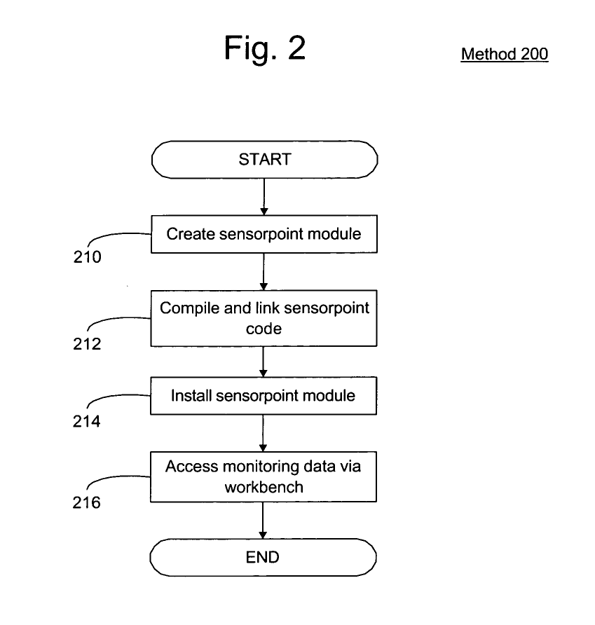

FIG. 2 shows an exemplary method 200 for software development according to the present invention that will be discussed with reference to the system 100. Beginning with step 210, a sensorpoint module is created using the workbench software 26. As previously discussed, the sensorpoint module is a software component that includes the compiled sensorpoint code and instructions relating to how the compiled sensorpoint code should be implemented. The workbench software 26 may be accessed using the user interface 22, or from the target 10 if the target 10 has its own user interface. If the sensorpoint module is a newly created module, the sensorpoint code is written, packaged within the module and stored in the database 24. Alternatively, if the sensorpoint module already exists, the existing sensorpoint code is modified and saved. The developer then specifies the user code 14 location(s) in which the branch instruction(s) should be placed.

In step 212, the sensorpoint code is compiled using the workbench software 26 and saved in the database 24 along with the rest of the sensorpoint module. The sensorpoint code is then linked. That is, the individual files (source, header, library, etc.) that comprise the sensorpoint code are combined into a single executable file (i.e., the executable binary). For example, if the programming language is C, the individual files may be placed into a User Sensorpoint Module (USM) file. An exemplary sensorpoint source code 215 may be written in the C programming language, compiled and linked on the host 20, saved as a sensorpoint object code 15, and transmitted to the target 10 for execution. Branch instructions are inserted into a specific location(s) (i.e., the instrumentation points) of the user code 14 as desired by the developer, and may also be transmitted from the host 20 as part of the sensorpoint module. In other embodiments, the sensorpoint source code 215 may be written and the instrumentation points specified through a user interface located on the target 10 itself. The branch instructions may be inserted by patching the running user code 14 with precompiled branch instructions pointing to the sensorpoint object code 15. When the application reaches the instrumentation point(s), the sensorpoint object code 15 is run before execution of the user code 14 resumes. Thus, the developer may debug and develop the user code 14 without having to recompile or interrupt the execution of the user program.

In step 214, the compiled sensorpoint source code 215 is installed by transmitting the compiled sensorpoint source code 215 as sensorpoint object code 15 from the host 20 to the target 10. The DSM agent 12 receives the sensorpoint object code 15, saves it into memory allocated to the sensorpoint object code 15, processes the executable binary and updates the user code 14 with the branch instructions. During this time, the target 10 continues to execute the user code 14 and does not encounter any interruption during running of the user code 14. If the user code 14 encounters the breakpoint(s) during execution, program execution is temporarily suspended in order to allow the sensorpoint program to execute.

In step 216, the monitoring data is accessed via the workbench software 26. The developer views the monitoring data, determines whether results of the user program are as expected and, if necessary, makes changes to the sensorpoint object code 15 by repeating steps 210-216.

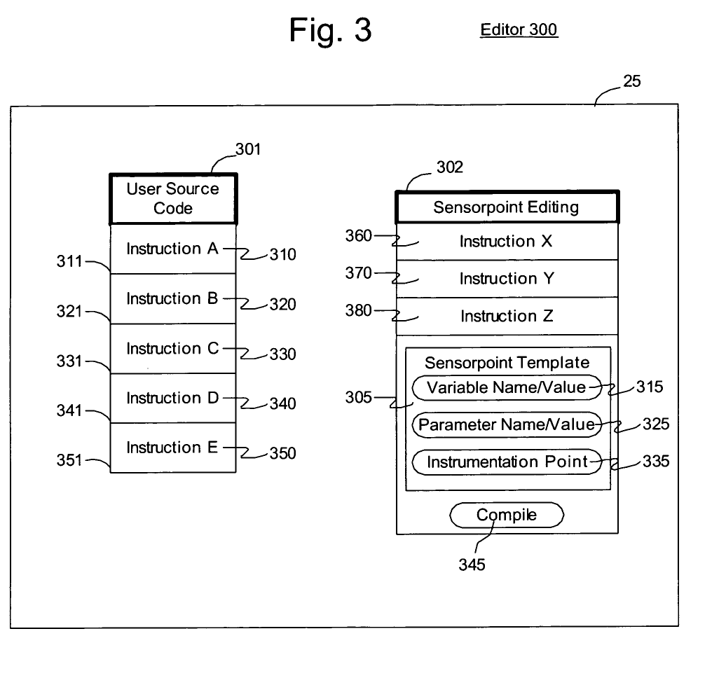

FIG. 3 shows an exemplary illustration of an editor 300 according to the present invention. The editor 300 includes a user source code view 301 of a running application and a sensorpoint editing view 302 having sensorpoint template 305. The exemplary editor 300 will be also described with reference to the exemplary system 100 of FIG. 1. The running application may be the source code corresponding to the user code 14 of the target 10. The source code may be written in any programming language (e.g., C, C++, Java, etc.) and may include variable names and values, as well as parameter names and values. It is important to note that while various sensorpoints, or an equivalent independently compile code, may have any type of functionality, the sensorpoint template 305 may serve as a uniform formatting tool for editing and writing sensorpoint code 15. Thus, aspects of the present invention may serve as a sensorpoint editor for building sensorpoints and placing the sensorpoints into precise locations within the running user code 14. Furthermore, both the user source code view 301 and the sensorpoint editing view 302 may be displayed to the developer via the GUI 25, wherein the developer may select a specific location for insertion from the user source code view 301 and may create and/or adjust the variables and parameters of the sensorpoint code 15 from the sensorpoint editing view 302.

Those skilled in the art would understand that the user source code view 301 and the sensorpoint editing view 302 may be displayed either on separate GUIs or within the same GUI. In addition, multiple GUIs may be used to represent multiple user codes and multiple sensorpoint codes. Therefore, exemplary embodiments of the present invention may allow one developer, or multiple developers, to see all of the sensorpoints modules that are available within a particular operating environment. Thus, multiple developers may avoid creating duplicate sensorpoints modules, thereby enabling knowledge-based problem resolution for the developers.

According to this exemplary editor 300, the user source code view 301 may display lines of instructions from the user code 14, such as, for example, Instruction A 310 at line 311, Instruction B 320 at line 321, Instruction C 330 at line 331, Instruction D 340 at line 341, and Instruction E 350 at line 351. Thus, the user source code view 301 may show the source code corresponding to the running user code 14 on the target 10. From the user source code view 301, the developer may select a particular line of code, or instruction, as the instrumentation point, thereby indicating where the sensorpoint object code 15 should be inserted. For example, the developer may select line 331 as the instrumentation point, as illustrated in the user source code view 301. According to this example, the sensorpoint object code 15 may be inserted after Instruction B 320 and before Instruction C 330. When the user code 14 reaches line 331, a branch instruction will direct the target 10 to execute Instruction X 360, Instruction Y 370, and Instruction Z 380 before the execution of Instruction C 330 of the user code 14. Upon completion of the sensorpoint object code 15, the user code 14 may resume. Thus, the running application on target 10 will perform the instructions of the user code 14 as follows: Instructions A-B-[X-Y-Z]-C-D-E, wherein the bracketed portion represents the instructions of the sensorpoint object code 15. Those skilled in the art would understand that the location of instrumentation point within user code 14 may vary, and furthermore, there may be more than one instrumentation point for the insertion of one of more sensorpoints. It is also important to note that while the developer may select a line of code, alternatively, the developer may select a function within the user code 14 or any other defined block of code within the user code 14 as the instrumentation point for the insertion of the desired sensorpoint. However, regardless of the instrumentation point, the editor 300 shows any view of the source code corresponding to the user code 14 so that the developer may easily select the instrumentation point for the insertion of the sensorpoint.

The sensorpoint editing view 302 may contain additional information, such as instructions for sensorpoint object code 15, (e.g., Instruction X 360, Instruction Y 370, and Instruction Z 380), variable names and values 315, parameter names and values 325, and the specific instrumentation point location 335 for the insertion of the sensorpoint object code 15 into within a running user code 14 once compiled and transmitted to the target 10. Having the sensorpoint editing view 302 display relevant information to the developer, the developer may write and edit the sensorpoint source code 215 by easily referring to the user source code view 301 to determine the variable names, parameter names, etc. Furthermore, the sensorpoint editing view 302 may utilize the sensorpoint template 305 to allow the developer to reuse and/or share the sensorpoint source code 215.

The sensorpoint source code 215 may be compiled and linked independently at an external location, such as at the host 20 (not shown), and subsequently transmitted to target 10 as the sensorpoint object code 15. More specifically, according to the exemplary illustration 300, a compiling function available on the sensorpoint editing view 302 may provide for independent compilation of the sensorpoint source code 215 which may be then downloaded to the target 10 for insertion. The compiling function may be performed through activating a compile button 345 on the sensorpoint editing view 302, where selecting the compile button 345 initiates the compiling and linking of the sensorpoint source code 215. Alternatively the compile button may be hidden from the editing view 302 and the compile function may be performed automatically, just prior to sending sensorpoint module to the target 10. As discussed above, once compiled and linked, the sensorpoint source code 215 becomes the sensorpoint object code 15. The execution of the sensorpoint object code 15 may be accomplished in the user code 14 of the target 10 via branch instructions inserted at the selected instrumentation point.

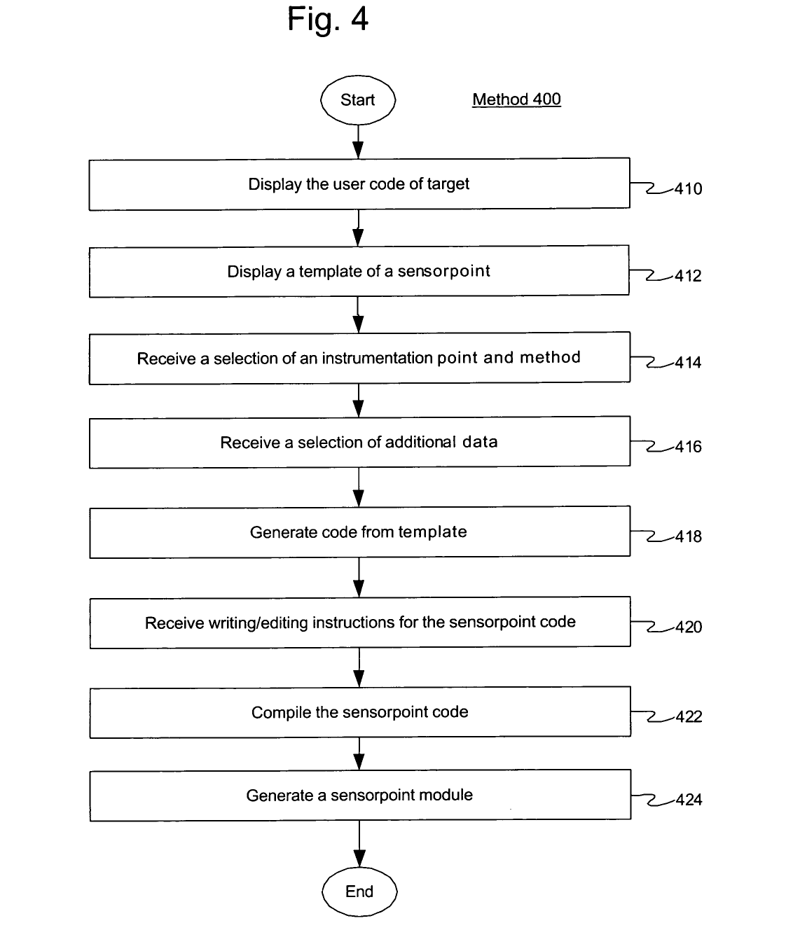

FIG. 4 shows an exemplary method 400 for editing a sensorpoint code prior to inserting into a running application on a target 10. The exemplary method 400 will be also described with reference to the exemplary system 100 of FIG. 1 and the exemplary editor 300 of FIG. 3 and may provide greater detail for step 210 of exemplary method 200 of FIG. 2. According to the present invention, the method 400 may provide a developer with a common template in order to allow the creation of sensorpoint source code 215. The editor 300 may also hide the template from the user's “view” in order to simulate a more natural programming environment. Furthermore, the template may be present in the compiled sensorpoint source code 215. The exemplary embodiment of the present invention provides that the editor 300 that may be used for the writing/editing of the sensorpoint source code 15, as well as the placement of the sensorpoint code 15 into a precise point of the user code 14 running on a target 10 without impacting the performance of the target 10.

In step 410, an exemplary embodiment of the present invention may utilize the display of the user interface 22 to show the developer the source code corresponding to the user code 14 that is running on a target 10 (e.g., the user source code view 301). The display may be a graphical viewer, such as editing GUI 25, providing the developer with a view of the source code corresponding to the user code 14. The GUI 25 may include editing features such as a listing of selectable variables from buttons, tabs, scroll bars, pull-down menus, etc. in order to aid the developer in the writing and editing process for the sensorpoint. The GUI 25 may further include various types of metadata specifications, such as timing metadata, to aid in the building of the sensorpoint. In addition, the GUI 25 may provide the developer with multiple perspectives of the running application on the deployed target 10 in an integrated environment. Each of the multiple perspectives of the GUI 25 may utilize visualization techniques for the insertion of additional data, as that data is needed for a particular perspective. Therefore, the data inserted for each of the multiple perspectives may be collected and stored at different times. Thus, the views may be called dynamically by the developer, thereby allowing data to be extracted from the running application of the target 10 at anytime.

For example, the user source code view 301 may include a plurality of views, each view corresponding to a different perspective of the source code. In one exemplary embodiment, the user source code view 301 may include a view that corresponds to the code portion that is currently running on the target 10. In order for this view to be operable, a connection must be established between the target device 10 and the host 20 where the editor 300 is being run. In another example, the developer may be able to select a variable and the user source code view 301 will display all the sections of code where the variable appears. In another example, the developer may select a particular function or procedure in the source code and the user source code view 301 may display all the calls in the source code to that function or procedure. Those skilled in the art will understand that the developer may customize the user source code view 301 to show any desired view of the source code that the developer finds useful for writing and/or editing sensorpoints.

In step 412, the editor may present the developer with a separate display of a sensorpoint template in, for example, the sensorpoint editing view 302. As described above, each sensorpoint may have different functionality, but there may be portions of code that are common to multiple sensorpoints that can be automatically generated by the editor. For example, as shown in FIG. 3, the sensorpoint template 305 of the sensorpoint editing view 302 may include the selection of an instrumentation point 335. As will be described in greater detail below, the developer may be able to select the instrumentation point by referring to the user source code view 301. After such a selection, the template 305 may include a certain portion of pre-generated user code 15 based on the selection of the instrumentation point (see step 414), thereby increasing the efficiency and organization of the editing of the sensorpoint code 15. Furthermore, templates may allow for several developers to easily understand and contribute edits to the sensorpoint code 15.

According to exemplary embodiments of the present invention, the sensorpoint template 305 may also display editable information, such as variable names, parameter names, etc. The template 305 may be set up in advance or may be cumulative based on the other writing/edits of the developer or other developers. For example, where multiple developers are working on the source code, the development project may extract every variable name from the user source code and include the variables in the template 305 (e.g., in a drop down menu), so that a developer writing a sensorpoint may select any variable. In another example, as developers write sensorpoints, the variables from the user source code that are used in the sensorpoints may be added to the template 305. By displaying the editable information in the sensorpoint template, the developer may enter or edit the sensorpoint source code 215 without having to refer back to the user source code view 301 in order to determine the variable names, parameter names, etc. Thus, the developer may easily enter variable references from the user code 14 into the sensorpoint code 15. However, as shown in FIG. 3, the user source code view 301 may be displayed simultaneously with the sensorpoint editing view 302, thereby making it easy for the developer to browse, find and select variables (or other code portions) from the user source code and insert them into the sensorpoint template 305. It is important to note that the developer may be presented with a plurality of various sensorpoint templates that may be based on, for example, the functionality of the sensorpoint (e.g., debugging, monitoring, maintenance, etc.).

In step 414, the exemplary embodiment of the present invention may receive a selection of an instrumentation point within the running user code 14 via the GUI 25. Within a particular view, such as the user source code view 301, of the GUI 25, the developer may be shown a visual representation corresponding to the user code 14 of the target 10. The user source code view 301 provides the developer with the ability to select a specific location of the user code 14 (e.g., line, function, defined block of code, etc.) as to where the sensorpoint code 15 should be inserted. The developer may use one or more of the editing features displayed on the GUI 25 in order to determine and select the specific location. For example, the developer may access the user source code view 301 of existing user code 14 by pressing a hot key or clicking a mouse button. As described above, the selection of the instrumentation point may be inserted into the template 305.

Also in step 414, the exemplary embodiment of the present invention may receive from the developer a selection of a method of insertion for the sensorpoint code 15. This method may be an “on entry” directive or an “on exit” directive, wherein the “on entry” and “on exit” directives may be defined as blocks of code to be executed just before or just after a thread executes a task, respectively. The “on entry” directive specifies that the associated user code 14 is to be executed before the sensorpoint code 15 is entered. Therefore, an exemplary “on entry block” of a task may be executed if a thread is given permission to execute that task. The “on exit” directive specifies that the user code 14 is to be executed just after the sensorpoint code 15 has exited, but before the user code 14 returns to its associates calling mechanism. Therefore, an exemplary “on exit block” of a task may be executed after the return statement (if one exists), but before control returns to a calling task. It is also possible to define additional data fields for the “on entry” and “on exit” blocks in order to communicate with each other. Thus, condition variables may be set and edited in these blocks. These conditional variables may be displayed to the developer via the GUI 25. Those of skill in the art understand that the “on entry” and “on exit” clauses are exemplary manners for the method for inserting the sensorpoint code 15 into the running application on the target 10.

In step 416, the editor 300 may receive additional data in the template 305. As described above, the template 305 may include additional data such as variable names 315 and parameter names 325. The developer may fill in this information in the GUI displaying the sensorpoint editing view 302. Also as described above, the developer may fill out this additional data based on information included in the template (e.g., by selecting data in the template 305) or by selecting the data as displayed in the user source code view 301 that is displayed simultaneously with the sensorpoint editing view 302. Those skilled in the art will understand that the template 305 is not limited to the components shown in FIG. 3 (e.g., variable names 315, parameter value 325, instrumentation point 335), but may include any other information that is used for the creating sensorpoints. For example, in addition to variable names, the template 305 may include operations that should be included in the sensorpoint. An exemplary operation may be to extract a value for a variable name. Thus, the template 305 may also include other data.

In step 418, the editor 300 generates the template code from the data that is entered into the template 305. As described above, each sensorpoint may have different functionality, but the editor 300 can take the data from the template 305 and generate template code based on the data. The template code may then be displayed in the sensorpoint editing view 302.

In step 420, the exemplary embodiment of the present invention may receive from the developer the writing and/or editing instructions for the sensorpoint code 15. The developer may write and edit new sensorpoint function into existing the sensorpoint code 15 using any text-editing tool. Through the use of the text-editing tool, the developer may manually enter sensorpoint directives, such as sensorpoint thread. Those skilled in the art may understand that a directive may be defined as a control statement that directs the operation of a feature within a program, such as an instruction to a programming language compiler as to how to compile the program. Optionally, the developer may write and edit sensorpoint instructions into multiple sensorpoint codes, wherein each sensorpoint code may has respective sensorpoint views.

In step 422, the exemplary embodiment of the present invention may use a compiler to compile the sensorpoint code 15 within the host 10. The compiler (e.g., an APC source file, “apc.exe”) may discover and reveal any syntax errors within the sensorpoint code 15. If there have been multiple sensorpoint codes generated, the developer may see each of the codes on the user interface 22 and select to compile all, or a subset, of the codes for a project. Finally, once the compilation is successful, in step 424, the exemplary embodiment may generate a sensorpoint module from the sensorpoint code 15. The sensorpoint module may subsequently be downloaded from the host 20 to the target 10. The developer may be presented with additional options such as initial state of the sensorpoint module. Thus, the sensorpoint module may enable the development and insertion of new instrumentation into running user code 14 of the deployed target 10 so that potential problems can be quickly identified without have to recreate the potential problems in a development environment. The editing feature of the exemplary embodiments of the present invention maybe a helpful link that enables developers to write, edit, compile, and deploy the sensorpoint code 15 with ease and accuracy.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A system, comprising:
a first view displaying a source user code corresponding to a user code running on a target device;
a second view displaying a template for an independent code to be compiled separately from the user code and inserted into the running user code, wherein a user fills in data in the template; and
a code generator generating source code for the independent code based on the data entered in the template, wherein the second view displays the source code after generation by the code generator.

2. The system of claim 1, wherein the system is located on a host device that is remote from the target device.

3. The system of claim 1, wherein the first view is a plurality of views, each of the plurality of views displaying aspects of the source user code.

4. The system of claim 1, wherein the first view and the second view are displayed simultaneously.

5. The system of claim 1, wherein the data of the template includes one of an insertion point for the independent code, a parameter name, a variable name and an operation.

6. The system of claim 1, wherein the second view provides a mechanism for the user to select the data to fill in the template.

7. The system of claim 6, wherein the mechanism is one of a pull-down menu and a dialog box.

8. The system of claim 1, wherein the first view provides a mechanism for the user to select the data to fill in the template of the second view.

9. The system of claim 1, wherein the second view further provides for editing the generated source code.

10. The system of claim 1, further comprising:
a compiler for compiling the generated source code to create the independent code, wherein the second view includes a mechanism for invoking the compiler.

11. A method, comprising:
displaying, in a first view, a source user code corresponding to a user code running on a target device;
displaying, in a second view, a template for an independent code to be compiled separately from the user code and inserted into the running user code;
receiving input data in the template; and
generating source code for the independent code based on the input data received in the template.

12. The method of claim 11, further comprising:
displaying, on the second view, the source code after generation.

13. The method of claim 11, further comprising:
compiling the generated source code to create the independent code.

14. The method of claim 13, further comprising:
transmitting the compiled independent code to the target device.

15. The method of claim 11, wherein the first view and the second view are displayed simultaneously.

16. The method of claim 11, wherein the data of the template includes one of an insertion point for the independent code, a parameter name, a variable name and an operation.

17. The method of claim 11, further comprising:
receiving a selection in the first view, the selection being the data for the template.

18. The method of claim 11, further comprising:
receiving, in the second view, edits for the generated source code.

19. The method of claim 11, wherein the first view is a plurality of views, each of the plurality of views displaying aspects of the source user code.

20. A system, comprising a memory storing a set of instructions and a processor executing the instructions, the set of instructions being operable to:
display, in a first view, a source user code corresponding to a user code running on a target device;
display, in a second view, a template for an independent code to be compiled separately from the user code and inserted into the running user code;
receive input data in the template; and
generate source code for the independent code based on the input data received in the template.
